(19) United States
(12) Patent Application Publication
(10) Pub. No.: US 2008/0111261 A1
(43) Pub. Date: May 15, 2008

(54) METHOD FOR PRODUCING SUBSTRATE ASSEMBLY FOR PLASMA DISPLAY PANEL

(75) Inventor: Tatsuya TORINARI, Miyazaki (JP)

Correspondence Address: STAAS & HALSEY LLP, SUITE 700, 1201 NEW YORK AVENUE, N.W., WASHINGTON, DC, 20005, US

(73) Assignee: Fujitsu Hitachi Plasma Display Limited, Miyazaki (JP)

(21) Appl. No.: 11/747,330

(22) Filed: May 11, 2007

(30) Foreign Application Priority Data
Nov. 10, 2006 (JP) 2006-305602

(51) Int. Cl. G02B 1/12

(52) U.S. Cl. 264/1.37

(57) ABSTRACT

A method for producing a substrate assembly for a plasma display panel includes the steps of providing a laser beam absorbing substance on a projection in the surface of a dielectric layer covering electrodes on a substrate, the laser beam absorbing substance absorbing a laser beam more easily than a material of the dielectric layer; and irradiating the laser beam absorbing substance with the laser beam to fuse and flatten the projection by heat generated in the laser beam absorbing substance by the irradiation.

### CROSS-REFERENCE TO RELATED APPLICATION

This application is related to Japanese Patent Application No. 2006-305602 filed on Nov. 10, 2006, whose priority is claimed and the disclosure of which is incorporated by reference in its entirety.

### BACKGROUND OF THE INVENTION

1. Field of the Invention

The present invention relates to a method for producing a substrate assembly for a plasma display panel (hereinafter, referred to as PDP).

2. Description of Related Art

FIG. 2 is a perspective view showing a structure of a conventional PDP. The PDP has a structure formed by bonding a front-side substrate assembly 1 and a rear-side substrate assembly 2 to each other. The front-side substrate assembly 1 includes a front-side substrate la which is a glass substrate, display electrodes 3 each made of a transparent electrode 3a and a bus electrode 3b and arranged on the front-side substrate 1a, and a dielectric layer 4 covering the display electrodes 3. Further, a protective layer 5 which is a magnesium oxide layer having a high secondary electron emission coefficient is formed on the dielectric layer 4. In the rear-side substrate assembly 2, address electrodes 6 are disposed on a rear-side substrate 2a which is a glass substrate so that the address electrodes 6 cross the display electrodes 3 at a right angle, and barrier ribs 7 for defining light emitting regions are provided between neighboring address electrodes 6 and red-, green-, and blue-emitting phosphor layers 8 are formed on the address electrodes 6 in regions divided by the barrier ribs 7. A Ne—Xe gas as discharge gas is introduced in an air-tight discharge space formed in a structure formed of the front-side substrate assembly 1 and the rear-side substrate assembly 2 bonded to each other. Although not shown, it should be noted that the address electrodes 6 are covered with a dielectric layer, and the barrier ribs 7 and the phosphor layer 8 are formed on the dielectric layer.

At the time of producing the front-side substrate assembly 1, the display electrodes 3 are formed on the front-side substrate 1a, and then the substrate surface is cleaned with cleaning fluid or pure water, thereby removing foreign matters adhered to the surface of the substrate. After that, the dielectric layer 4 is formed.

Although many of foreign matters are removed by the cleaning process, some flat foreign matters and the like may be firmly adhered to the surface of the substrate and remain on the substrate surface without being removed in the cleaning process. There is also a case that a foreign matter is adhered on the substrate surface after the cleaning process.

When the dielectric layer 4 is formed by a thin film forming method such as CVD in a state where a foreign matter exists on the substrate surface, the surface shape of the dielectric layer 4 becomes the shape in which the shape of the foreign matter is reflected. As a result, a projection is formed in the surface of the dielectric layer 4.

Normally, after formation of the dielectric layer 4, a cleaning process using a cleaning brush is performed. In the process, there is a case such that the projection and the cleaning brush interfere with each other and the dielectric layer 4 is peeled in the projection part. There is a case that the dielectric layer 4 is peeled so that the display electrode 3 below the dielectric layer 4 is exposed, and it may cause dielectric breakdown.

When the front-side substrate assembly 1 and the rear-side substrate assembly 2 are bonded to each other, there is a case such that the projection in the surface of the dielectric layer 4 interferes with the barrier ribs 7 in the rear-side substrate assembly 2 and destroys the barrier ribs 7. Therefore, a technique for eliminating the projection in the surface of the dielectric layer 4 is in demand.

### SUMMARY OF THE INVENTION

The present invention has been achieved in view of such circumstances and provides a method for producing a substrate assembly for a PDP capable of easily eliminating a projection in a dielectric layer.

A method for producing a substrate assembly for a PDP of the present invention includes the steps of providing a laser beam absorbing substance on a projection in the surface of a dielectric layer covering electrodes on a substrate, the laser beam absorbing substance absorbing a laser beam more easily than a material of the dielectric layer; and irradiating the laser beam absorbing substance with the laser beam to fuse and flatten the projection by heat generated in the laser beam absorbing substance by the irradiation.

In the present invention, the laser beam absorbing substrate is provided on a projection and irradiated with a laser beam. The projection is fused by heat generated at the time of irradiation so that the projection is flattened. Therefore, even when the material of the projection does not absorb a laser beam so much, the projection can be fused and flattened. By flattening the projection, the projection can be substantially eliminated.

### BRIEF DESCRIPTION OF THE DRAWINGS

FIGS. 1A to 1F are cross-sectional views showing a process for producing a front-side substrate assembly for a PDP as an embodiment of the invention; and

FIG. 2 is a perspective view showing the structure of a conventional PDP.

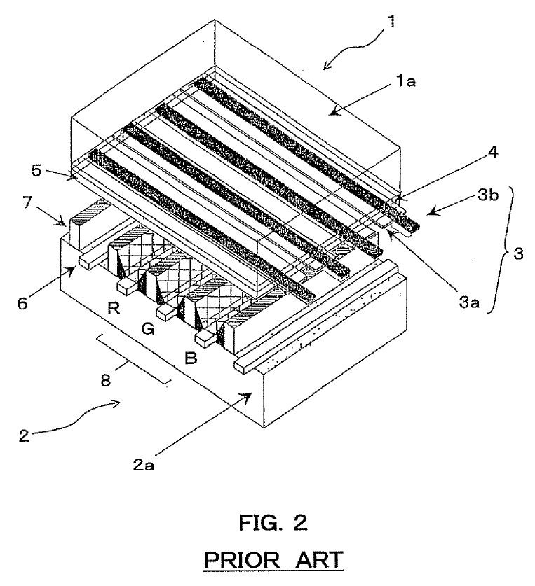

### DESCRIPTION OF THE PREFERRED EMBODIMENTS

An embodiment of the present invention will be described below with reference to the drawings. The configurations shown in the drawings and the following description are illustrative, and the scope of the invention is not limited by the drawings and the following description, The following embodiment relates to, as an example, the case where a front-side substrate assembly includes display electrodes, a dielectric layer, and a protective layer. The invention can be also applied to the case where a rear-side substrate assembly is provided with display electrodes, a dielectric layer, a protection layer, and the like. In the following embodiment, a projection in the surface of the dielectric layer covering the display electrodes will be described as an example. There is also a case that a projection is formed in the surface of a dielectric layer covering address electrodes, and the projection can be also flattened by a similar method.

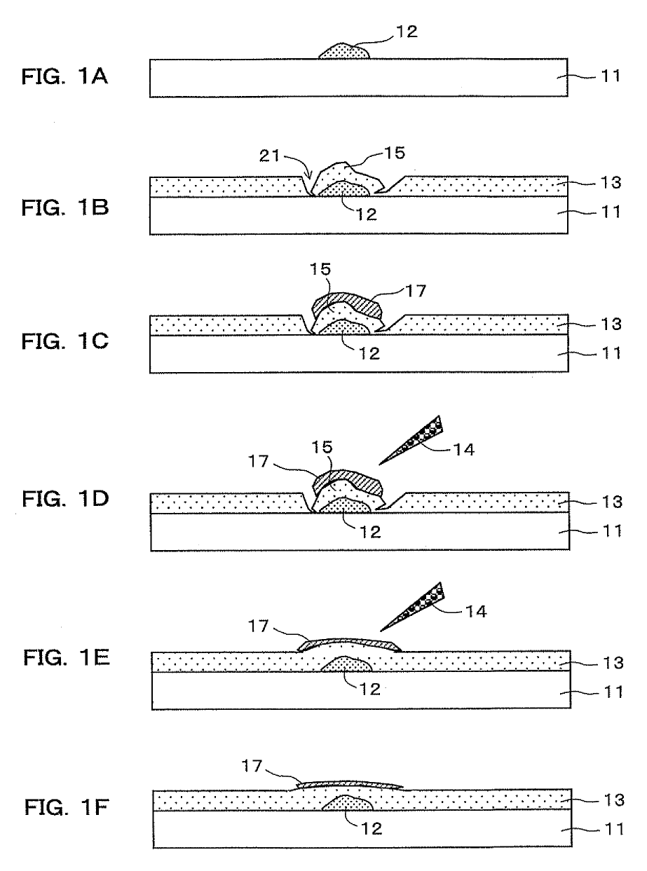

A method for producing a front-side substrate assembly for a PDP as an embodiment of the invention will be described with reference to FIGS. 1A to 1F.

A method for producing a substrate assembly for a PDP of the embodiment includes the steps of providing a laser beam absorbing substance 17 on a projection 15 in the surface of a dielectric layer 13 covering display electrodes (not shown) on a front-side substrate 11, the laser beam absorbing substance 17 absorbing a laser beam 14 more easily than the material of a dielectric layer 13, and irradiating the laser beam absorbing substance 17 with the laser beam 14 to fuse and flatten the projection 15 by heat generated in the laser beam absorbing substance 17 by the irradiation.

Various processes related to the embodiment will be described below.

### 1. Display Electrodes Forming Process

First, display electrodes are formed on the front-side substrate 11.

The front-side substrate 11 is not limited and any of substrates known in this field can be used. Examples of the front-side substrate 11 are transparent substrates such as a glass substrate and a plastic substrate.

The display electrode may be an electrode made of a transparent electrode material such as ITO or SnO₂ or an electrode made of a metal electrode material such as Ag, Au, Al, Cu, or Cr can be used. Concretely, for example, the display electrode is an electrode constructed by a wide transparent electrode made of ITO, SnO₂, or the like and a narrow bus electrode made of a metal such as Ag, Au, Al, Cu, or Cr and a stacked body of the materials (for example, Cr/Cu/Cr stack structure). The display electrode made of Ag or Au can be formed by using a printing method, and the display electrode made of the other materials can be formed by a combination of etching and a film forming method such as evaporation, sputtering, or the like with the desired number of electrodes, thickness, width, and interval.

### 2. Cleaning Process

Next, the substrate surface after formation of the display electrodes is cleaned. The substrate surface can be cleaned by passing a cleaning brush over the substrate surface in the presence of a cleaning fluid or pure water. By the cleaning, many foreign matters are removed. However, as shown in FIG. 1A, there is a case that a foreign matter 12 having a flat shape or the like is firmly adhered to the substrate surface and remains without being removed. There is also a case such that, after the cleaning, the foreign matter 12 is adhered to the substrate surface. The shape and size of the foreign matter are not limited. For example, the foreign matter 12 has a height of approximately 1 to 10 μm, and the diameter of a circumscribed circle is approximately 50 to 300 μm.

### 3. Dielectric Layer Forming Process

As shown in FIG. 1B, the dielectric layer 13 is formed on the cleaned substrate. The dielectric layer 13 is formed with a thickness of 10 μm or less (for example, 3 to 10 μm) by using CVD. When such a method is used, the outer shape of the foreign matter 12 is reflected in the surface shape of the dielectric layer 13, and the projection 15 tends to be formed. Consequently, the necessity to flatten the projection 15 by the method of the embodiment is particularly high.

The shape of the projection 15 is not limited and may be a sharp projection from the surface of the dielectric layer 13 or a gentle projection such that the dielectric layer 13 locally thickens. A recess 21 formed due to the influence of the foreign matter 12 may exist around the projection 15.

The projection 15 includes not only a projection formed due to the influence of the foreign matter 12 but also a projection formed by other causes (for example, local abnormal thickening due to abnormal film formation). Here, the abnormal thickening will be described in detail. In CVD, there is a case such that a hole in a shower nozzle for dispersing material gas of the dielectric layer becomes locally big, the flow rate of the material gas increases, and the film becomes locally thick.

The material of the dielectric layer 13 is not particularly limited and is, for example, silicon dioxide (SiO₂). When the material is SiO₂, the necessity of employing the method of the present invention is particularly high. This is because SiO₂ is transparent for the laser beam 14 (that is, SiO₂ does not substantially absorb the laser beam 14), and consequently, the projection 15 cannot be fused without the existence of the laser beam absorbing substance 17 on the projection 15.

### 4. Foreign Matter or Projection Detecting Process

Next, the foreign matter 12 on the substrate surface or the projection 15 on the surface of the dielectric layer 13 is detected. The foreign matter 12 can be detected, for example, by detecting a shadow created when the dielectric layer 13 is irradiated with light from an oblique direction (for example, at an incidence angle of 30 to 60 degrees). If the foreign matter 12 exists, a shadow is created in a position adjacent to the foreign matter 12. Consequently, by detecting the shadow, the foreign matter 12 can be detected.

If the foreign matter 12 exists, usually, the projection 15 is formed in the surface of the dielectric layer 13. Therefore, by detecting the foreign matter 12, the projection 15 can be also detected. The foreign matter 12 or the projection 15 may be detected by the other methods.

### 5. Process for Providing Laser Beam Absorbing Substance on Projection

As shown in FIG. 1C, the laser beam absorbing substance 17 which absorbs the laser beam 14 more easily than the material of the dielectric layer 13 is provided on the detected projection 15.

The characteristics required for the laser beam absorbing substance 17 are that (a) the laser beam absorbing substance 17 absorbs the laser beam 14 to be used more easily than the material of the dielectric layer 13, and (b) even when the laser beam absorbing substance 17 is heated to the melting point of the dielectric layer 13, at least part of the laser beam absorbing substance 17 remains on the projection 15 (in other words, at least part of the laser beam absorbing substance 17 does not evaporate or is not burnt). In the case where the laser beam absorbing substance 17 has such characteristics, the laser beam absorbing substance 17 can be irradiated with the laser beam 14 to fuse and flatten the projection by heat generated by the irradiation.

The laser beam absorbing substance 17 is not particularly limited as long as it has the above characteristics. An example of the laser beam absorbing substance 17 is a paste made of low-melting glass powder (for example, about 360° C.), a binder resin, a solvent, and powder of a metal apt to absorb the laser beam 14 (that is, powder of a metal absorbing the laser beam more easily than the material of the dielectric layer 13) and having a boiling point higher than the melting point of the material of the dielectric layer 13 (preferably, a metal such as Cr (chromium) having a melting point higher than the melting point of the material of the dielectric layer 13). In this case, the laser beam absorbing substance 17 in the paste form is provided on the projection 15 and sintered, for example, at a temperature which is about the melting point of the glass powder (for example a temperature within ±50 degrees, preferably ±40 degrees, more preferably ±30 degrees, more preferably ±20 degrees, and more preferably ±10 degrees of the melting point of the glass powder), thereby solidifying the laser beam absorbing substance 17. After that, the laser beam absorbing substance 17 is irradiated with a laser beam. The metal included in the laser beam absorbing substance 17 absorbs the laser beam and is heated and, by heat generated at that time, the projection 15 is melted. Since the laser beam absorbing substance 17 which absorbs the laser beam more easily than the material of the dielectric layer is solidified prior to irradiation of the laser beam, scatter of the laser beam absorbing substance 17 is suppressed,

In place of the paste, a paste containing a binder resin, a solvent, and the metal powder, a paste containing a binder resin liquid and the metal powder, or the like can be also employed as the laser beam absorbing substance 17. A substance containing only a resin which does not evaporate or is not burnt at the melting point of the material of the dielectric layer 13 can be employed as the laser beam absorbing substance 17.

The method of providing the laser beam absorbing substance 17 on the projection 15 is not particularly limited. Examples of the method are a method of smearing the projection 15 with the laser beam absorbing substance 17 and a method of adhering the laser beam absorbing substance 17 to the projection 15.

The laser beam absorbing substance 17 is preferably liquid or paste. In this case, as an example, the laser beam absorbing substance 17 is adhered to the tip of a needle. The tip of the needle with the laser beam absorbing substance 17 is made close to the projection 15 so that the laser beam absorbing substance 17 comes into contact with and is adhered to the projection 15. In such a manner, the laser beam absorbing substance 17 can be provided on the projection 15.

### 6. Laser Beam Irradiating Process

As shown in FIGS. 1D to 1F, the laser beam absorbing substance 17 is irradiated with the laser beam 14 to melt and flatten the projection 15 by heat generated in the laser beam absorbing substance 17 by the irradiation.

Irradiation parameters (wavelength, spot diameter, output, irradiation speed (that is, scan speed), irradiation time, and the like) of the laser beam 14 are not limited and are properly determined in accordance with the characteristics (absorption spectrum, melting point, boiling point, combustion temperature, and the like) of the laser beam absorbing substance 17, the characteristics (absorption spectrum, melting point, and the like) of the material of the dielectric layer 13, the size of the projection 15, and the like. The wavelength of the laser beam 14 is preferably a wavelength at which the laser beam absorbing substance 17 absorbs the laser beam easily and is properly determined by, for example, referring to the absorption spectrum of the laser beam absorbing substance 17. The spot diameter of the laser beam 14 is properly determined in consideration of, for example, the density of energy to be added to the laser beam absorbing substance 17. The output, irradiation speed, and irradiation time of the laser beam 14 are properly determined so that, for example, the laser beam absorbing substance 17 does not evaporate or is not burnt.

For example, the irradiation parameters of the laser beam 14 are wavelength: 1064 nm (the wavelength of a YAG laser), spot diameter: 40 to 60 μm, output: 0.5 to 1.0 W, and irradiation speed: 5 to 10 μm/s.

For example, the irradiation parameters of the laser beam 14 are determined as follows.

(a) First, the wavelength of the laser beam 14 is determined on the basis of the absorption spectrum of the laser beam absorbing substance 17. The spot diameter, output, and irradiation speed of the laser beam 14 are tentatively determined.

(b) Next, the laser beam absorbing substance 17 existing on the dielectric layer 13 is irradiated with the laser beam 14 with the determined irradiation parameters.

(c) When the laser beam 14 is judged to be too weak because of the reason that the dielectric layer 13 is not melted by the irradiation or the like, the spot diameter is decreased, the output is increased, or the irradiation speed is lowered. When the laser beam 14 is judged to be too strong because of the reason that the laser beam absorbing substance 17 scatters by the irradiation of (b) or the like, the spot diameter is increased, the output is decreased, or the irradiation speed is increased.

(d) The irradiation of (b) is performed again with the irradiation parameters changed in (c) and, after that, it is judged whether the irradiation parameters are proper or not by the method of (c). Until satisfactory irradiation parameters are found, the operations (b) and (c) are repeated. In the case where satisfactory irradiation parameters are not found, the wavelength of the laser beam 14 is changed or the laser beam absorbing substance 17 is changed.

In the specification, “flatten” denotes reduction in the height of the projection 15. Therefore, as shown in FIG. 1F, the case where the slightly raised part remains after the irradiation of the laser beam is also included in the term of “flatten”.

The laser beam absorbing substance 17 may be removed after flattening the projection 15 or is allowed to remain. It is considered that the influence of the laser beam absorbing substance 17 remained is not large since the laser beam absorbing substance 17 usually exists in a small area.

### 7. Dielectric Layer Cleaning Process

Next, the surface of the dielectric layer 13 is cleaned. In an example, cleaning is performed by passing a cleaning brush over the substrate surface in the presence of a cleaning fluid or pure water. In the embodiment, since the projection 15 is already flattened, the projection 15 and the cleaning brush do not interfere with each other, the dielectric layer 13 in the projection is not peeled off, and the display electrode is not exposed. In the case where the foreign matter 12 exists, there is a case such that the recess 21 is formed around the foreign matter 12 (refer to FIG. 1B) and the dielectric layer 13 is easily peeled. In the embodiment, however, the recess 21 is buried at the time of flattening the projection 15, so that the problem of peeling of the dielectric layer 13 is solved in this respect, too.

### 8. Protective Layer Forming Process

A protective layer made of magnesium oxide or the like is formed on the dielectric layer 13, and the production of the front-side substrate assembly is completed. The projection 15 may be flattened after the protective layer is formed. In this case, the effect of preventing peeling of the dielectric layer 13 in the “7. dielectric layer cleaning process” cannot be obtained but an effect of preventing interference between the projection 15 and the barrier ribs in the following “9. bonding process” can be obtained.

### 9. Bonding Process

Next, a panel having a an air-tight discharge space therein is formed by bonding the front-side substrate assembly and a separately-produced rear-side substrate assembly in which address electrodes, barrier ribs, phosphor layers, and the like are provided. The front-side substrate assembly and the rear-side substrate assembly are bonded to each other so that the display electrodes and the address electrodes are orthogonal to each other.

Conventionally, when the front-side substrate assembly and the rear-side substrate assembly are bonded to each other, a projection in the surface of the dielectric layer in the front-side substrate assembly and the barrier rib in the rear-side substrate assembly interfere with each other, and a problem occurs such that the barrier rib is destroyed by the interference. In the embodiment, however, the projection is already flattened, thus such a problem does not occur.

### 10. Discharge Gas Filling Process

Next, the discharge space in the panel is evacuated and the discharge gas made of neon, xenon, and the like is introduced into the discharge space, thereby a PDP is produced. The PDP has a plurality of discharge cells at intersections of the display electrodes and the address electrodes between the front-side substrate assembly and the rear-side substrate assembly.

Various features included in the foregoing embodiment can be employed singularly or in combination for the present invention.

What is claimed is:

1. A method for producing a substrate assembly for a plasma display panel comprising the steps of providing a laser beam absorbing substance on a projection in the surface of a dielectric layer covering electrodes on a substrate, the laser beam absorbing substance absorbing a laser beam more easily than a material of the dielectric layer; and
irradiating the laser beam absorbing substance with the laser beam to fuse and flatten the projection by heat generated in the laser beam absorbing substance by the irradiation.

2. The method of claim 1, wherein the material of the dielectric layer comprises silicon oxide, and the laser beam absorbing substance comprises a paste containing chromium powder.

3. The method of claim 1, further comprising a step of sintering the laser beam absorbing substance on the projection to solidify the laser beam absorbing substance, before the irradiation of the laser beam,
the laser beam absorbing substance comprising a paste made of low-melting glass powder, a binder resin, a solvent, and powder of a metal absorbing the laser beam more easily than the material of the dielectric layer and having a boiling point higher than the melting point of the material of the dielectric layer.

4. The method of claim 3, wherein the metal has a melting point higher than the melting point of the material of the dielectric layer

5. The method of claim 4, wherein the metal comprises chromium.

6. The method of claim 3, wherein the material of the dielectric layer comprises silicon oxide.

7. The method of claim 4, wherein the material of the dielectric layer comprises silicon oxide.

8. The method of claim 5, wherein the material of the dielectric layer comprises silicon oxide.

9. The method of claim 1, wherein the laser beam comprises a YAG laser beam.

10. The method of claim 2, wherein the laser beam comprises a YAG laser beam.

11. The method of claim 3, wherein the laser beam comprises a YAG laser beam.

12. The method of claim 4, wherein the laser beam comprises a YAG laser beam.

13. The method of claim 5, wherein the laser beam comprises a YAG laser beam.

14. The method of claim 1, wherein the laser beam absorbing substance is liquid or paste, and
the laser beam absorbing substance is provided on the projection by adhering the laser beam absorbing substance to a tip of a needle, and making the tip of the needle close to the projection so that the laser beam absorbing substance comes into contact with and is adhered to the projection.

15. The method of claim 2, wherein the laser beam absorbing substance is liquid or paste, and
the laser beam absorbing substance is provided on the projection by adhering the laser beam absorbing substance to a tip of a needle, and making the tip of the needle close to the projection so that the laser beam absorbing substance comes into contact with and is adhered to the projection.

16. The method of claim 3, wherein the laser beam absorbing substance is liquid or paste, and
the laser beam absorbing substance is provided on the projection by adhering the laser beam absorbing substance to a tip of a needle, and making the tip of the needle close to the projection so that the laser beam absorbing substance comes into contact with and is adhered to the projection.

17. The method of claim 4, wherein the laser beam absorbing substance is liquid or paste, and
the laser beam absorbing substance is provided on the projection by adhering the laser beam absorbing substance to a tip of a needle, and making the tip of the needle close to the projection so that the laser beam absorbing substance comes into contact with and is adhered to the projection.

18. The method of claim 5, wherein the laser beam absorbing substance is liquid or paste, and
the laser beam absorbing substance is provided on the projection by adhering the laser beam absorbing substance to a tip of a needle, and making the tip of the needle close to the projection so that the laser beam absorbing substance comes into contact with and is adhered to the projection.
